(19) United States
(12) Patent Application Publication
(10) Pub. No.: US 2026/0366109 A1
(43) Pub. Date: Nov. 19, 2026

(54) NON-ORIENTED ELECTRICAL STEEL SHEET AND MANUFACTURING METHOD THEREFOR

(71) Applicant: HYUNDAI STEEL COMPANY, Incheon (KR)

(72) Inventors: Jae Hyeon Koh, Seoul (KR); Kang Roh Lee, Chungcheongnam-do (KR); Yong Keun Ahn, Gangwon-do (KR)

(21) Appl. No.: 19/722,605

(22) Filed: Jun. 26, 2026

Related U.S. Application Data
(63) Continuation of application No. PCT/KR2024/096748, filed on Dec. 11, 2024.

(30) Foreign Application Priority Data
Dec. 29, 2023 (KR) 10-2023-0197878

(51) Int. Cl. C22C 38/02; C21D 6/00; C21D 8/1216; C21D 8/1244; C21D 9/46; C22C 38/00; C22C 38/04; C22C 38/06

(52) U.S. Cl. CPC C22C 38/02; C21D 6/005; C21D 6/008; C21D 8/1222; C21D 8/1233; C21D 8/1261; C21D 8/1272; C21D 9/46; C22C 38/004; C22C 38/04; C22C 38/06

(57) ABSTRACT

The present disclosure relates to a non-oriented electrical steel sheet and a manufacturing method therefor. According to the non-oriented electrical steel sheet and the manufacturing method therefor of the present application, the non-oriented electrical steel sheet can have excellent magnetic properties, and specifically, can have low iron loss.

### CROSS-REFERENCE TO THE RELATED APPLICATIONS

This application is a continuation of International Application No. PCT/KR2024/096748 filed Dec. 11, 2024, which claims the benefit of Korean Patent Application No. 10-2023-0197878, filed Dec. 29, 2023, in the Ministry of Intellectual Property, the entire contents of which applications are incorporated herein by reference.

### FIELD

In one aspect, the present disclosure relates to a non-oriented electrical steel sheet and a manufacturing method therefor.

### BACKGROUND

Currently, emissions of greenhouse gases generated from various industries and daily life are steadily increasing worldwide, and efforts toward carbon neutrality are underway globally to reduce them. In particular, for internal combustion engine vehicles that emit large amounts of greenhouse gases by using fossil fuels, electric vehicles are receiving considerable attention as an alternative, and accordingly, research on electric vehicles is being actively conducted.

The drive motor serves as the power source for electric vehicles, and plays a role as a core component. Consequently, research aimed at improving the efficiency of drive motors constitutes a vital factor in achieving carbon neutrality. Non-oriented electrical steel sheets are used as the material for such drive motors, and are typically produced by punching and then stacking cold-rolled steel sheets of 0.65 mm or less.

These non-oriented electrical steel sheets possess a BCC crystal structure, the fastest spin occurs when the orientations of the magnetic domains form angles of 0° and 900 relative to the BCC crystal axes, and magnetic domain wall motion occurs easily too as rapid spinning occurs, thereby exhibiting excellent magnetic properties. However, it is extremely difficult to form crystals close to these angles, and in order to resolve this issue, it is necessary to reduce the thickness of the steel sheet, increase its Si content, and rigorously control impurity elements. Therefore, there is a need for a non-oriented electrical steel sheet and a method of manufacturing the same to solve these problems.

### SUMMARY

It is an object of the present disclosure to provide a non-oriented electrical steel sheet having excellent magnetic properties, and a method of manufacturing the same.

In order to achieve the above object, a non-oriented electrical steel sheet of the present disclosure comprises
a) Si in an amount of i) 0.6 wt % or greater and ii) 1.6 wt % or less,
b) Al in an amount of i) 0.1 wt % or greater and ii) 0.5 wt % or less, and
c) Mn in an amount of i) 0.2 wt % or greater and ii) 0.4 wt % or less, and
d) one or more of: C in an amount of i) greater than 0 ppm and ii) 30 ppm or less, S in an amount of i) greater than 0 ppm and ii) 30 ppm or less, N in an amount of i) greater than 0 ppm and ii) 30 ppm or less, Ti in an amount of i) greater than 0 ppm and ii) 30 ppm or less, and P in an amount of i) greater than 0 ppm and ii) 1000 ppm or less, and
e) one or more of: Y in amount of i) greater than 0 ppm and ii) 30 ppm or less and Ho in an amount of i) greater than 0 ppm and ii) 30 ppm or less, with the balance being Fe and other unavoidable impurities, wherein an average M_{AVG} of a magnetic domain spin alignment value M calculated by General Formula 1 below is 1.22 or less.

M=(sin²α sin²β)+(sin²β sin²γ)+(sin²γ sin²α) [General Formula 1]

In General Formula 1 above, α, β, and γ are derived from crystal orientations measured under a step size condition of 10 μm via EBSD on a specimen of 20 mm in width and 20 mm in length manufactured from the non-oriented electrical steel sheet, and with respect to x-, y-, and z-axes defined in a three-dimensional crystal coordinate system, a is an angle formed between the x-axis and a crystal grain orientation, p is an angle formed between the y-axis and a crystal grain orientation, and 7 is an angle formed between the z-axis and a crystal grain orientation.

The above weight percents are based on total weight of the steel sheet material. Unless otherwise indicated, weight percent of a component are in reference to or based on total weight of the sheet or other material.

The non-oriented electrical steel sheet may contain Y at greater than 0 ppm and 30 ppm or less, and Ho at greater than 0 ppm and 30 ppm or less.

In addition, the non-oriented electrical steel sheet may contain C at greater than 0 ppm and 30 ppm or less, S at greater than 0 ppm and 30 ppm or less, N at greater than 0 ppm and 30 ppm or less, Ti at greater than 0 ppm and 30 ppm or less, and P at greater than 0 ppm and 1000 ppm or less.

In addition, the non-oriented electrical steel sheet may have a thickness of greater than 0.3 mm and 0.6 mm or less.

In addition, a method of manufacturing a non-oriented electrical steel sheet of the present disclosure comprises the steps of: then hot-rolling a slab comprising a) Si in an amount of i) 0.6 wt % or greater and ii) 1.6 wt % or less, b) Al in an amount of i) 0.1 wt % or greater and ii) 0.5 wt % or less, and c) Mn in an amount of i) 0.2 wt % or greater and ii) 0.4 wt % or less, and d) one or more of: C in an amount of i) greater than 0 ppm and ii) 30 ppm or less, S in an amount of i) greater than 0 ppm and ii) 30 ppm or less, N in an amount of i) greater than 0 ppm and ii) 30 ppm or less, Ti in an amount of i) greater than 0 ppm and ii) 30 ppm or less, and P in an amount of i) greater than 0 ppm and ii) 1000 ppm or less, and e) one or more of: Y in amount of i) greater than 0 ppm and ii) 30 ppm or less and Ho in an amount of i) greater than 0 ppm and ii) 30 ppm or less, with the balance being Fe and other unavoidable impurities; preliminarily annealing the hot-rolled steel sheet; manufacturing a cold-rolled steel sheet by cold-rolling the preliminarily annealed hot-rolled steel sheet; and finally annealing the cold-rolled steel sheet, wherein the non-oriented electrical steel sheet has an average M_{AVG} of a magnetic domain spin alignment value M, calculated by General Formula 1 below, of 1.22 or less.

M=(sin²α sin²β)+(sin²β sin²γ)+(sin²γ sin²α). [General Formula 1]

In General Formula 1 above, α, β, and γ are derived from crystal orientations measured under a step size condition of 10 μm via EBSD on a specimen of 20 mm in width and 20 mm in length manufactured from the non-oriented electrical steel sheet, and with respect to x-, y-, and z-axes defined in a three-dimensional crystal coordinate system, α is an angle formed between the x-axis and a crystal grain orientation, β is an angle formed between the y-axis and a crystal grain orientation, and γ is an angle formed between the z-axis and a crystal grain orientation.

Suitably, in the above method, the slab is reheated and hot-rolled.

In addition, the slab may contain Y at greater than 0 ppm and 30 ppm or less, and Ho at greater than 0 ppm and 30 ppm or less.

In addition, the slab may contain C at greater than 0 ppm and 30 ppm or less, S at greater than 0 ppm and 30 ppm or less, N at greater than 0 ppm and 30 ppm or less, Ti at greater than 0 ppm and 30 ppm or less, and P at greater than 0 ppm and 1000 ppm or less.

In addition, the step of preliminarily annealing may be performed by heat-treating the hot-rolled steel sheet at 950 °C or greater and 1100 °C or less for 30 seconds or greater and 150 seconds or less.

According to the non-oriented electrical steel sheet and the method of manufacturing the same of the present application, excellent magnetic properties can be achieved, and specifically, low iron loss can be attained.

### DETAILED DESCRIPTION

The present disclosure relates to a non-oriented electrical steel sheet, which is an iron core material used in motors that convert electrical energy into mechanical energy. The non-oriented electrical steel sheet contains Si at 0.6 wt % or greater and 1.6 wt % or less, Al at 0.1 wt % or greater and 0.5 wt % or less, and Mn at 0.2 wt % or greater and 0.4 wt % or less, contains one or more of C at greater than 0 ppm and 30 ppm or less, S at greater than 0 ppm and 30 ppm or less, N at greater than 0 ppm and 30 ppm or less, Ti at greater than 0 ppm and 30 ppm or less, and P at greater than 0 ppm and 1000 ppm or less, and contains one or more of Y at greater than 0 ppm and 30 ppm or less and Ho at greater than 0 ppm and 30 ppm or less, with the balance being Fe and other unavoidable impurities, wherein the average M_{AVG} of the magnetic domain spin alignment value M calculated by General Formula 1 below is 1.22 or less.

M=(sin²α sin²β)+(sin²β sin²γ)+(sin²γ sin²α). [General Formula 1]

In General Formula 1 above, α, β, and γ are derived from crystal orientations measured under a step size condition of 10 μm via EBSD on a specimen of 20 mm in width and 20 mm in length manufactured from the non-oriented electrical steel sheet, and with respect to x-, y-, and z-axes defined in a three-dimensional crystal coordinate system, α is the angle formed between the x-axis and the crystal grain orientation, β is the angle formed between the y-axis and the crystal grain orientation, and γ is the angle formed between the z-axis and the crystal grain orientation.

Specifically, the non-oriented electrical steel sheet may have an average M_{AVG} of the magnetic domain spin alignment value M of 1.22 or less, or 1.219 or less. In this case, the non-oriented electrical steel sheet may have a lower limit for the average M_{AVG} of the magnetic domain spin alignment value M of 1.0 or greater, 1.05 or greater, 1.1 or greater, or 1.15 or greater. By ensuring that the average M_{AVG} of the magnetic domain spin alignment value M falls within the aforementioned range, the non-oriented electrical steel sheet can exhibit excellent magnetic properties, and specifically, can exhibit low iron loss. In this case, the M_{AVG} refers to the average of the magnetic domain spin alignment values M measured from the crystal orientations of all crystals under the aforementioned conditions.

The components of the non-oriented electrical steel sheet will be described below.

### Si: 0.6 wt % or Greater and 1.6 wt % or Less

Silicon (Si) is an element that reduces iron loss by increasing the electrical resistivity of the non-oriented electrical steel sheet. If the silicon is contained in the non-oriented electrical steel sheet in an amount below the lower limit of the aforementioned range, it may be difficult to achieve the low iron loss characteristics required for the non-oriented electrical steel sheet. In addition, if the silicon is contained in the non-oriented electrical steel sheet in an amount exceeding the upper limit of the aforementioned range, magnetic permeability and magnetic flux density may decrease, and the strength and brittleness of the steel sheet may increase, thereby leading to a problem of increasing the difficulties in the production process. Therefore, the silicon can be contained in the non-oriented electrical steel sheet in an amount of 0.6 wt % or greater and 1.6 wt % or less, specifically, in an amount of 0.63 wt % or greater and 1.6 wt % or less.

### Mn: 0.2 wt % or Greater and 0.4 wt % or Less

Manganese (Mn) is an element that, together with Si, reduces iron loss by increasing electrical resistivity and improves the crystallographic texture. If the manganese is contained in the non-oriented electrical steel sheet in an amount below the lower limit of the aforementioned range, fine MnS may precipitate, thereby inhibiting grain growth and increasing iron loss. In addition, if the manganese is contained in the non-oriented electrical steel sheet in an amount exceeding the upper limit of the aforementioned range, coarse MnS may precipitate, thereby increasing iron loss and degrading magnetic properties where magnetic flux density decreases. Therefore, the manganese can be contained in the non-oriented electrical steel sheet in an amount of 0.2 wt % or greater and 0.4 wt % or less, specifically, in an amount of 0.2 wt % or greater and 0.39 wt % or less.

### Al: 0.1 wt % or Greater and 0.5 wt % or Less

Aluminum (Al) is an element that, together with Si, reduces iron loss by increasing electrical resistivity, and induces the precipitation of AlN by meeting with nitrogen (N). If the aluminum is contained in the non-oriented electrical steel sheet in an amount below the lower limit of the aforementioned range, the electrical resistivity may be insufficient, thereby causing an increase in iron loss. Further, if the aluminum is contained in the non-oriented electrical steel sheet in an amount exceeding the upper limit of the aforementioned range, cold rolling workability may deteriorate, and magnetic flux density may decrease, thereby degrading magnetic properties. Therefore, the aluminum can be contained in the non-oriented electrical steel sheet in an amount of 0.1 wt % or greater and 0.5 wt % or less, specifically, in an amount of 0.1 wt % or greater and 0.49 wt % or less.

C: Greater than 0 ppm and 30 ppm or Less

Carbon (C) is an element that can form carbides such as TiC and/or NbC by combining with other unavoidable impurities and can increase iron loss. If the carbon is contained in the non-oriented electrical steel sheet in an amount exceeding the upper limit of the aforementioned range, it may induce magnetic aging and adversely affect magnetic properties. Therefore, the carbon can be contained in the non-oriented electrical steel sheet in an amount of greater than 0 ppm and 30 ppm or less.

S: Greater than 0 ppm and 30 ppm or Less

Sulfur (S) is an element that combines with other unavoidable impurities and forms sulfides such as MnS and/or CuS, and if contained in an amount exceeding the upper limit of the aforementioned range, it may increase iron loss and inhibit grain growth. Therefore, the sulfur can be contained in the non-oriented electrical steel sheet in an amount of greater than 0 ppm and 30 ppm or less.

N: Greater than 0 ppm and 30 ppm or Less

Nitrogen (N) is an element that combines with other unavoidable impurities and forms nitrides such as AlN, TiN, and/or NbN, and if contained in an amount exceeding the upper limit of the aforementioned range, it may increase iron loss and inhibit grain growth. Therefore, the nitrogen can be contained in the non-oriented electrical steel sheet in an amount of greater than 0 ppm and 30 ppm or less.

Ti: Greater than 0 ppm and 30 ppm or Less

Titanium (Ti) is an element that combines with other unavoidable impurities and forms fine carbides, nitrides, or the like, such as TiC and/or TiN, and if contained in an amount exceeding the upper limit of the aforementioned range, it may degrade magnetic properties by inhibiting grain growth. Therefore, the titanium can be contained in the non-oriented electrical steel sheet in an amount of greater than 0 ppm and 30 ppm or less.

P: Greater than 0 ppm and 1000 ppm or Less

Phosphorus (P) is a grain boundary segregation element and an element that develops crystallographic texture. If the phosphorus is contained in the non-oriented electrical steel sheet in an amount exceeding the upper limit of the aforementioned range, grain growth may be inhibited due to segregation effects, magnetic properties may deteriorate, and cold rolling workability may decrease. Therefore, the phosphorus can be contained in the non-oriented electrical steel sheet in an amount of greater than 0 ppm and 1000 ppm or less.

Y: Greater than 0 ppm and 30 ppm or Less

Yttrium (Y) is an element that improves magnetic properties by combining with Ho, thereby reducing iron loss. If the yttrium is contained in the non-oriented electrical steel sheet in an amount exceeding the upper limit of the aforementioned range, coarse precipitates such as Y₂O₃, YS, and/or Y₂S₃ may form, thereby increasing iron loss and degrading magnetic properties. Therefore, the yttrium can be contained in the non-oriented electrical steel sheet in an amount of greater than 0 ppm and 30 ppm or less.

Ho: Greater than 0 ppm and 30 ppm or Less

Holmium (Ho) is an element that results in high magnetic permeability and excellent magnetic properties, i.e., reduction of iron loss, by combining with Y. If the holmium is contained in the non-oriented electrical steel sheet in an amount exceeding the upper limit of the aforementioned range, excessive precipitates may form, causing an increase in iron loss and thereby degrading magnetic properties. Therefore, the holmium can be contained in the non-oriented electrical steel sheet in an amount of greater than 0 ppm and 30 ppm or less.

The balance Fe and other unavoidable impurities

The unavoidable impurities are impurities introduced during the steelmaking and manufacturing processes of the non-oriented electrical steel sheet, and since these are widely known in the art, detailed descriptions thereof will be omitted. In one embodiment of the present application, the addition of elements other than the aforementioned components of the non-oriented electrical steel sheet is not precluded, and such elements may be contained in various ways within a scope that does not compromise the technical concept of the present application. If additional elements are further contained, they may be contained in place of the balance iron (Fe).

For example, the unavoidable impurities may be zirconium (Zr), niobium (Nb), or the like, and may contain Zr in an amount of 0.0020 wt % or less and/or Nb in an amount of 0.0020 wt % or less in the non-oriented electrical steel sheet.

In one example, the non-oriented electrical steel sheet may contain both the Y and Ho, and for example, may contain Y in an amount of greater than 0 ppm and 30 ppm or less, and Ho in an amount of greater than 0 ppm and 30 ppm or less. Specifically, the non-oriented electrical steel sheet may contain Y in an amount of 3 ppm or greater and 30 ppm or less, or 6 ppm or greater and 29 ppm or less, and Ho in an amount of 3 ppm or greater and 29 ppm or less, or 6 ppm or greater and 29 ppm or less. The specific descriptions on the Y and Ho are the same as those provided above, and will thus be omitted.

In another example, the non-oriented electrical steel sheet may contain all of the C, S, N, Ti, and P, and for example, may contain C in an amount of greater than 0 ppm and 20 ppm or less, S in an amount of greater than 0 ppm and 20 ppm or less, N in an amount of greater than 0 ppm and 20 ppm or less, Ti in an amount of greater than 0 ppm and 20 ppm or less, and P in an amount of greater than 0 ppm and 150 ppm or less. Specifically, the non-oriented electrical steel sheet may contain C in an amount of 3 ppm or greater and 30 ppm or less, or 6 ppm or greater and 29 ppm or less, S in an amount of 3 ppm or greater and 30 ppm or less, or 6 ppm or greater and 29 ppm or less, N in an amount of 3 ppm or greater and 29 ppm or less, or 5 ppm or greater and 28 ppm or less, Ti in an amount of 3 ppm or greater and 30 ppm or less, or 6 ppm or greater and 30 ppm or less, and P in an amount of 30 ppm or greater and 970 ppm or less, or 60 ppm or greater and 940 ppm or less. The specific descriptions on the C, S, N, Ti, and P are the same as those provided above, and will thus be omitted.

In one example, the non-oriented electrical steel sheet may have a thickness of greater than 0.3 mm and 0.6 mm or less, and specifically, 0.35 mm or greater and 0.58 mm or less, 0.40 mm or greater and 0.56 mm or less, or 0.45 mm or greater and 0.54 mm or less. By having a thickness within the aforementioned range, the non-oriented electrical steel sheet can exhibit excellent iron loss as eddy current loss is reduced.

For example, the non-oriented electrical steel sheet may have an iron loss W_{15/50} of 6.1 W/kg or less, specifically, 6.09 W/kg or less. From the perspective that the lower the iron loss W_{15/50} of the non-oriented electrical steel sheet, the better the magnetic properties are, its lower limit is not particularly restricted, but may be 1 W/kg or greater, for example. The iron loss W_{15/50} refers to the iron loss when a magnetic flux density of 1.5 T is induced at a low frequency of 50 Hz. In this case, the iron loss W_{15/50} was measured in accordance with the IEC 60404-2 standard.

In addition, the non-oriented electrical steel sheet may have an average grain size of 50 μm or greater and 150 μm or less, and the deformation texture formed during cold rolling can be completely, i.e., 99% or greater, recrystallized in the final annealing process. By ensuring that the average grain size satisfies the aforementioned range, the non-oriented electrical steel sheet can exhibit excellent magnetic properties, specifically, low iron loss. In contrast, for the non-oriented electrical steel sheet, if the average grain size falls below the lower limit of the aforementioned range, hysteresis loss may increase due to the fine grain size, and further, if it exceeds the upper limit of the aforementioned range, eddy current loss may increase, resulting in an increase in iron loss.

In one example, the non-oriented electrical steel sheet may further include a coating layer on its surface. The coating layer is an insulating coating layer formed on the surface of the non-oriented electrical steel sheet, and may be referred to as an insulating film. Since the insulating film is widely known, a detailed description thereof will be omitted. For example, the coating layer may be formed by applying a chromium-free (Cr-free) coating solution, i.e., an organic-inorganic composite coating solution containing no chromium, to the surface of the finally annealed steel sheet, and then baking it. In this case, the coating layer may be formed to a thickness of 0.2 μm to 5 μm. By further including the coating layer formed on its surface, the non-oriented electrical steel sheet can reduce eddy current loss by maintaining electrical insulation between the upper and lower non-oriented electrical steel sheets when the non-oriented electrical steel sheets are stacked in a plurality.

The present disclosure also relates to a method of manufacturing a non-oriented electrical steel sheet. The method of manufacturing a non-oriented electrical steel sheet relates to a method of manufacturing the aforementioned non-oriented electrical steel sheet, and specific details of a non-oriented electrical steel sheet to be described below will be omitted as the content described in the non-oriented electrical steel sheet above can be applied in the same manner.

The method of manufacturing a non-oriented electrical steel sheet of the present disclosure includes a hot rolling step, a preliminary annealing step, a step of manufacturing a cold-rolled steel sheet, and a final annealing step, and the manufactured non-oriented electrical steel sheet has an average M_{AVG} of the magnetic domain spin alignment value M, calculated by the aforementioned General Formula 1, of 1.22 or less. According to the method of manufacturing a non-oriented electrical steel sheet of the present application, by ensuring that the average M_{AVG} of the magnetic domain spin alignment value M calculated by the aforementioned General Formula 1 satisfies the aforementioned range, the manufactured non-oriented electrical steel sheet can exhibit excellent magnetic properties, specifically, low iron loss.

The hot rolling step is a step for manufacturing a slab into a hot-rolled steel sheet, and is performed by reheating and then hot rolling the slab. Since the composition of the slab is identical to that of the non-oriented electrical steel sheet and all details described in the non-oriented electrical steel sheet apply equally here, a description thereof will be omitted. The reheating temperature for the slab is not particularly limited, but may be, for example, 1000 °C or greater and 1250 °C or less, specifically, 1100 °C or greater and 1150 °C or less. If the reheating temperature for the slab falls below the lower limit of the aforementioned range, the rolling load may increase during the hot rolling, and if it exceeds the upper limit of the aforementioned range, precipitates such as C, S, N, Y, Ho, or the like within the slab may re-dissolve, leading to the formation of fine precipitates in subsequent processes, which may inhibit grain growth and adversely affect magnetic properties.

In addition, the finish rolling temperature during the hot rolling may be 860 °C or greater and 900 °C or less, specifically, 880 °C or greater and 900 °C or less. Further, the hot-rolled steel sheet obtained by the hot rolling may be coiled at 550 °C or greater and 650 °C or less. The thickness of the hot-rolled steel sheet may be 1.8 mm or greater and 2.6 mm or less. If the thickness of the hot-rolled steel sheet exceeds the upper limit of the aforementioned range, the reduction ratio during cold rolling may increase, and crystallographic texture may thus be degraded. Therefore, the thickness of the hot-rolled steel sheet can be controlled to fall within the aforementioned range.

The preliminary annealing step is a step for increasing orientations favorable for magnetic properties, and can be performed by heat-treating the hot-rolled steel sheet. Specifically, the preliminary annealing step can be performed by heating to 950 °C or greater and 1100 °C or less at a heating rate of 20 °C/s or greater in a nitrogen atmosphere, holding at this temperature range for 30 seconds or greater and 150 seconds or less, and then cooling at a cooling rate of 30 °C/s or greater. In this case, the preliminary annealing can be performed by uncoiling the coiled hot-rolled steel sheet. If the annealing temperature during the preliminary annealing of the hot-rolled steel sheet exceeds the upper limit of the aforementioned range, grains may grow excessively, resulting in large variations in grain size and increased oxidation, which may adversely affect the magnetic properties of the final product. Further, if the annealing temperature during the preliminary annealing of the hot-rolled steel sheet falls below the lower limit of the aforementioned range, grain growth may be insufficient, resulting in the formation of fine grains, which may adversely affect the magnetic properties of the final product. In addition, if the holding time during the annealing of the hot-rolled steel sheet falls below the lower limit of the aforementioned range, non-uniform grain growth may occur, which may adversely affect the magnetic properties of the final product. Thereafter, the annealed hot-rolled steel sheet can be cooled at a cooling rate of 30 °C/s or greater. Thereafter, the annealed hot-rolled steel sheet may further undergo pickling to remove the oxide layer formed on its surface via a pickling solution.

The step of manufacturing the cold-rolled steel sheet is a step for manufacturing the hot-rolled steel sheet into a cold-rolled steel sheet, and is performed through cold rolling. The reduction ratio during the cold rolling may be 60% or greater and 90% or less. The thickness of the cold-rolled steel sheet may be greater than 0.3 mm and 0.60 mm or less.

The final annealing step is a step for ensuring magnetic properties by growing grains to a particular size, and is performed by heat-treating the cold-rolled steel sheet. For example, the final annealing can be performed by heat-treating the cold-rolled steel sheet at 800 °C to 1150 °C for 20 seconds to 150 seconds. Specifically, the final annealing can be performed by heating the cold-rolled steel sheet to 800 °C to 1150 °C or 850 °C to 1050 °C at a heating rate of 10 °C/s or greater, and then heat-treating it in this temperature range for 20 seconds to 150 seconds or 30 seconds to 120 seconds. Thereafter, the finally annealed steel sheet can be cooled at a cooling rate of 30 °C/s or greater. By having the final annealing step performed in the aforementioned ranges of heating rate, temperature, duration, and cooling rate, iron loss can be reduced, and an optimal grain size that takes mechanical properties into account can be derived. In contrast, if the heating rate, temperature, and duration in the final annealing step fall below the lower limits of the aforementioned ranges, the grain size may become finer, thereby causing an increase in hysteresis loss. Further, if the heating rate, temperature, and duration in the final annealing step exceed the upper limits of the aforementioned ranges, the grain size may become coarser, thereby causing an increase in eddy current loss.

In this case, the final annealing step can be performed under a mixed-atmosphere condition in order to prevent surface oxidation and nitridation. Specifically, the final annealing step can be performed in an atmosphere with hydrogen of 1% or greater and 30% or less and nitrogen of 70% or greater and 99% or less, or more specifically, hydrogen of 1% or greater and 40% or less and nitrogen of 60% or greater and 99% or less. By having the final annealing step performed under the atmosphere within the aforementioned ranges, the method of manufacturing a non-oriented electrical steel sheet allows the surface condition of the manufactured non-oriented electrical steel sheet to be smoother.

In the non-oriented electrical steel sheet, the average size of the grains formed on the surface in the final annealing process can be 40 μm or greater and 100 μm or less, and the deformation texture formed in the preceding cold rolling step can be recrystallized completely, i.e., 99% or greater. For the non-oriented electrical steel sheet, if the average size of the grains in the final annealing process falls below the lower limit of the aforementioned range, hysteresis loss may increase due to the fine grain size, and further, if it exceeds the upper limit of the aforementioned range, eddy current loss may increase, thereby causing an increase in iron loss.

In another example, the method of manufacturing a non-oriented electrical steel sheet may further include a step of forming a coating layer. The step of forming the coating layer can be performed on the surface of the finally annealed steel sheet, and specifically, can be performed on the surface of the steel sheet on which heat treatment has been performed during the final annealing. A specific description of the coating layer is the same as that provided for the non-oriented electrical steel sheet above, and will thus be omitted.

In the following, the present disclosure will be described in greater detail through embodiments according to the present disclosure and comparative examples not according to the present application, but the scope of the present disclosure is not limited by the embodiments presented below.

### Embodiment 1

### Manufacture of Non-Oriented Electrical Steel Sheet

A slab was manufactured by steelmaking and continuous casting with the components shown in Table 1 below, along with the balance Fe and other unavoidable impurities, reheated at a temperature of 1150 °C, and then hot-rolled with a finishing temperature of 890 °C, thereby manufacturing a hot-rolled steel sheet with a sheet thickness of 2.0 mm.

Thereafter, the hot-rolled steel sheet was coiled at a coiling temperature of 600 °C.

Thereafter, the hot-rolled steel sheet was annealed by heating it to 1000 °C at a heating rate of 20 °C/s in an atmosphere of 100% nitrogen, holding it at this temperature for 100 seconds, and then cooling it at a cooling rate of 30 °C/s.

Thereafter, the annealed hot-rolled steel sheet was cold-rolled with a reduction ratio of 75%, thereby manufacturing a cold-rolled steel sheet with a thickness of 0.5 mm.

Thereafter, the cold-rolled steel sheet was heated to 850 °C at a heating rate of 20 °C/s in an atmosphere of 10% hydrogen and 90% nitrogen, held at this temperature for 60 seconds, then cooled at a cooling rate of 30 °C/s, and finally annealed, thereby manufacturing a non-oriented electrical steel sheet.

### Embodiments 2 to 20 and Comparative Examples 1 to 54

### Manufacture of Non-Oriented Electrical Steel Sheets

Each non-oriented electrical steel sheet was manufactured in the same method as in Embodiment 1, except that the composition of the slab was modified to the components shown in Table 1 below and the balance Fe and other unavoidable impurities, the preliminary annealing conditions were modified to those shown in Table 2 below, and the finally annealed steel sheet was modified to have the thickness shown in Table 1 below by pressing at each reduction ratio during the cold rolling.

TABLE 1

| | | Slab composition | | | | | | | | | |
|---|---|---|---|---|---|---|---|---|---|---|---|
| | Thickness | wt % | | | ppm | | | | | | |
| | (mm) | Si | Al | Mn | C | S | N | Ti | P | Y | Ho |
| Embodiment 1 | 0.48 | 0.93 | 0.10 | 0.37 | 22 | 9 | 14 | 16 | 793 | 22 | 22 |
| Embodiment 2 | 0.49 | 0.65 | 0.24 | 0.39 | 6 | 12 | 17 | 11 | 664 | 29 | 8 |
| Embodiment 3 | 0.48 | 0.78 | 0.20 | 0.31 | 13 | 6 | 11 | 18 | 791 | 7 | 12 |
| Embodiment 4 | 0.50 | 1.07 | 0.12 | 0.29 | 28 | 20 | 7 | 8 | 807 | 15 | 19 |
| Embodiment 5 | 0.48 | 0.63 | 0.34 | 0.35 | 14 | 11 | 15 | 16 | 142 | 7 | 26 |
| Embodiment 6 | 0.51 | 0.91 | 0.13 | 0.36 | 28 | 9 | 23 | 7 | 594 | 20 | 20 |
| Embodiment 7 | 0.49 | 1.09 | 0.41 | 0.34 | 11 | 27 | 7 | 16 | 450 | 27 | 21 |
| Embodiment 8 | 0.51 | 0.71 | 0.29 | 0.23 | 14 | 22 | 9 | 23 | 390 | 13 | 14 |
| Embodiment 9 | 0.50 | 0.84 | 0.35 | 0.29 | 7 | 20 | 27 | 7 | 78 | 20 | 20 |
| Embodiment 10 | 0.47 | 0.69 | 0.40 | 0.23 | 7 | 6 | 21 | 20 | 805 | 13 | 6 |
| Embodiment 11 | 0.53 | 0.79 | 0.34 | 0.32 | 8 | 28 | 8 | 6 | 774 | 20 | 24 |
| Embodiment 12 | 0.52 | 0.64 | 0.39 | 0.30 | 15 | 9 | 11 | 14 | 164 | 9 | 6 |
| Embodiment 13 | 0.50 | 0.81 | 0.29 | 0.23 | 20 | 22 | 11 | 22 | 171 | 16 | 25 |
| Embodiment 14 | 0.50 | 0.75 | 0.22 | 0.25 | 9 | 10 | 7 | 6 | 329 | 29 | 6 |
| Embodiment 15 | 0.49 | 0.98 | 0.39 | 0.28 | 18 | 13 | 7 | 27 | 815 | 9 | 25 |
| Embodiment 16 | 0.52 | 0.63 | 0.16 | 0.39 | 27 | 28 | 15 | 11 | 606 | 21 | 24 |
| Embodiment 17 | 0.53 | 0.69 | 0.49 | 0.27 | 20 | 19 | 28 | 6 | 515 | 15 | 15 |
| Embodiment 18 | 0.54 | 1.07 | 0.29 | 0.29 | 24 | 15 | 7 | 14 | 240 | 17 | 24 |
| Embodiment 19 | 0.49 | 0.97 | 0.18 | 0.27 | 25 | 27 | 19 | 7 | 370 | 12 | 11 |
| Embodiment 20 | 0.50 | 0.94 | 0.19 | 0.37 | 20 | 29 | 20 | 7 | 936 | 16 | 17 |
| Comparative | 0.52 | 0.52 | 0.40 | 0.23 | 26 | 12 | 27 | 11 | 760 | 14 | 12 |
| Example 1 | | | | | | | | | | | |
| Comparative | 0.49 | 0.54 | 0.53 | 0.32 | 8 | 9 | 30 | 28 | 563 | 29 | 10 |
| Example 2 | | | | | | | | | | | |
| Comparative | 0.49 | 0.58 | 0.51 | 0.37 | 32 | 12 | 12 | 14 | 484 | 10 | 12 |
| Example 3 | | | | | | | | | | | |
| Comparative | 0.53 | 0.56 | 0.54 | 0.33 | 15 | 13 | 28 | 14 | 267 | 35 | 19 |
| Example 4 | | | | | | | | | | | |
| Comparative | 0.51 | 0.55 | 0.09 | 0.23 | 17 | 31 | 39 | 26 | 297 | 17 | 22 |
| Example 5 | | | | | | | | | | | |
| Comparative | 0.48 | 0.56 | 0.28 | 0.18 | 20 | 25 | 16 | 27 | 999 | 8 | 24 |
| Example 6 | | | | | | | | | | | |
| Comparative | 0.50 | 0.57 | 0.08 | 0.23 | 5 | 25 | 28 | 15 | 866 | 32 | 24 |
| Example 7 | | | | | | | | | | | |
| Comparative | 0.50 | 0.57 | 0.21 | 0.35 | 13 | 24 | 18 | 11 | 840 | 34 | 31 |
| Example 8 | | | | | | | | | | | |
| Comparative | 0.54 | 0.58 | 0.09 | 0.39 | 20 | 7 | 26 | 23 | 653 | 19 | 0 |
| Example 9 | | | | | | | | | | | |
| Comparative | 0.48 | 0.57 | 0.08 | 0.21 | 13 | 14 | 6 | 29 | 558 | 0 | 19 |
| Example 10 | | | | | | | | | | | |
| Comparative | 0.49 | 0.59 | 0.22 | 0.37 | 35 | 24 | 6 | 22 | 695 | 30 | 14 |
| Example 11 | | | | | | | | | | | |
| Comparative | 0.54 | 0.56 | 0.11 | 0.25 | 33 | 25 | 32 | 39 | 143 | 28 | 29 |
| Example 12 | | | | | | | | | | | |
| Comparative | 0.47 | 0.59 | 0.21 | 0.36 | 15 | 29 | 38 | 29 | 275 | 14 | 35 |
| Example 13 | | | | | | | | | | | |
| Comparative | 0.49 | 0.57 | 0.32 | 0.29 | 10 | 9 | 28 | 26 | 648 | 32 | 9 |
| Example 14 | | | | | | | | | | | |
| Comparative | 0.52 | 0.58 | 0.32 | 0.30 | 21 | 34 | 33 | 13 | 220 | 17 | 17 |
| Example 15 | | | | | | | | | | | |
| Comparative | 0.53 | 0.54 | 0.20 | 0.13 | 10 | 25 | 18 | 5 | 1220 | 11 | 27 |
| Example 16 | | | | | | | | | | | |
| Comparative | 0.51 | 0.58 | 0.21 | 0.36 | 26 | 9 | 16 | 32 | 200 | 21 | 39 |
| Example 17 | | | | | | | | | | | |
| Comparative | 0.51 | 0.53 | 0.15 | 0.45 | 36 | 29 | 28 | 11 | 71 | 28 | 28 |
| Example 18 | | | | | | | | | | | |
| Comparative | 0.50 | 0.51 | 0.25 | 0.47 | 24 | 26 | 37 | 15 | 1283 | 15 | 9 |
| Example 19 | | | | | | | | | | | |
| Comparative | 0.50 | 0.59 | 0.47 | 0.25 | 18 | 5 | 12 | 20 | 200 | 0 | 8 |
| Example 20 | | | | | | | | | | | |
| Comparative | 0.49 | 0.79 | 0.07 | 0.38 | 9 | 16 | 7 | 9 | 887 | 23 | 7 |
| Example 21 | | | | | | | | | | | |
| Comparative | 0.47 | 1.41 | 0.08 | 0.28 | 17 | 26 | 32 | 22 | 396 | 0 | 12 |
| Example 22 | | | | | | | | | | | |
| Comparative | 0.49 | 1.02 | 0.04 | 0.34 | 7 | 34 | 29 | 22 | 833 | 0 | 36 |
| Example 23 | | | | | | | | | | | |
| Comparative | 0.51 | 1.35 | 0.08 | 0.29 | 15 | 8 | 7 | 8 | 351 | 0 | 0 |
| Example 24 | | | | | | | | | | | |
| Comparative | 0.47 | 1.49 | 0.07 | 0.33 | 19 | 22 | 7 | 22 | 205 | 18 | 0 |
| Example 25 | | | | | | | | | | | |
| Comparative | 0.51 | 0.87 | 0.06 | 0.26 | 5 | 6 | 12 | 16 | 441 | 0 | 27 |
| Example 26 | | | | | | | | | | | |
| Comparative | 0.47 | 0.89 | 0.20 | 0.14 | 14 | 8 | 15 | 10 | 444 | 28 | 28 |
| Example 27 | | | | | | | | | | | |
| Comparative | 0.54 | 1.17 | 0.19 | 0.17 | 25 | 23 | 36 | 26 | 772 | 26 | 25 |
| Example 28 | | | | | | | | | | | |
| Comparative | 0.46 | 0.77 | 0.12 | 0.13 | 33 | 39 | 19 | 21 | 295 | 5 | 17 |
| Example 29 | | | | | | | | | | | |
| Comparative | 0.47 | 1.09 | 0.29 | 0.18 | 13 | 10 | 27 | 23 | 271 | 34 | 17 |
| Example 30 | | | | | | | | | | | |
| Comparative | 0.49 | 0.78 | 0.12 | 0.28 | 37 | 32 | 22 | 16 | 365 | 14 | 28 |
| Example 31 | | | | | | | | | | | |
| Comparative | 0.48 | 1.04 | 0.40 | 0.37 | 38 | 9 | 11 | 12 | 355 | 32 | 16 |
| Example 32 | | | | | | | | | | | |
| Comparative | 0.48 | 1.51 | 0.37 | 0.35 | 36 | 9 | 28 | 14 | 913 | 0 | 7 |
| Example 33 | | | | | | | | | | | |
| Comparative | 0.48 | 1.49 | 0.19 | 0.22 | 36 | 11 | 9 | 20 | 942 | 0 | 0 |
| Example 34 | | | | | | | | | | | |
| Comparative | 0.49 | 1.21 | 0.19 | 0.23 | 11 | 39 | 22 | 13 | 998 | 16 | 24 |
| Example 35 | | | | | | | | | | | |
| Comparative | 0.48 | 1.53 | 0.35 | 0.20 | 13 | 31 | 10 | 9 | 292 | 0 | 0 |
| Example 36 | | | | | | | | | | | |
| Comparative | 0.48 | 0.76 | 0.13 | 0.25 | 29 | 35 | 39 | 6 | 482 | 27 | 11 |
| Example 37 | | | | | | | | | | | |
| Comparative | 0.52 | 1.24 | 0.24 | 0.20 | 28 | 34 | 7 | 33 | 1175 | 10 | 27 |
| Example 38 | | | | | | | | | | | |
| Comparative | 0.47 | 1.11 | 0.31 | 0.38 | 6 | 31 | 38 | 17 | 120 | 18 | 28 |
| Example 39 | | | | | | | | | | | |
| Comparative | 0.48 | 1.24 | 0.20 | 0.30 | 10 | 40 | 10 | 18 | 283 | 32 | 38 |
| Example 40 | | | | | | | | | | | |
| Comparative | 0.46 | 1.32 | 0.16 | 0.26 | 13 | 23 | 34 | 15 | 87 | 20 | 18 |
| Example 41 | | | | | | | | | | | |
| Comparative | 0.51 | 0.92 | 0.12 | 0.20 | 24 | 10 | 31 | 32 | 228 | 13 | 8 |
| Example 42 | | | | | | | | | | | |
| Comparative | 0.49 | 1.52 | 0.26 | 0.35 | 22 | 16 | 35 | 13 | 690 | 38 | 36 |
| Example 43 | | | | | | | | | | | |
| Comparative | 0.46 | 0.91 | 0.33 | 0.29 | 8 | 10 | 33 | 13 | 427 | 0 | 0 |
| Example 44 | | | | | | | | | | | |
| Comparative | 0.46 | 0.80 | 0.26 | 0.22 | 13 | 10 | 11 | 36 | 346 | 11 | 16 |
| Example 45 | | | | | | | | | | | |
| Comparative | 0.53 | 1.37 | 0.23 | 0.36 | 15 | 12 | 13 | 32 | 1125 | 16 | 27 |
| Example 46 | | | | | | | | | | | |
| Comparative | 0.53 | 0.70 | 0.15 | 0.32 | 11 | 20 | 9 | 34 | 616 | 17 | 31 |
| Example 47 | | | | | | | | | | | |
| Comparative | 0.54 | 1.52 | 0.25 | 0.38 | 7 | 26 | 10 | 31 | 420 | 35 | 39 |
| Example 48 | | | | | | | | | | | |
| Comparative | 0.48 | 1.11 | 0.18 | 0.24 | 6 | 15 | 25 | 9 | 628 | 32 | 13 |
| Example 49 | | | | | | | | | | | |
| Comparative | 0.50 | 1.30 | 0.17 | 0.30 | 17 | 10 | 21 | 22 | 259 | 31 | 31 |
| Example 50 | | | | | | | | | | | |
| Comparative | 0.46 | 0.68 | 0.16 | 0.28 | 29 | 10 | 9 | 30 | 228 | 22 | 36 |
| Example 51 | | | | | | | | | | | |
| Comparative | 0.47 | 1.39 | 0.42 | 0.31 | 27 | 23 | 11 | 8 | 233 | 0 | 25 |
| Example 52 | | | | | | | | | | | |
| Comparative | 0.48 | 0.81 | 0.23 | 0.29 | 24 | 6 | 24 | 30 | 835 | 23 | 0 |
| Example 53 | | | | | | | | | | | |
| Comparative | 0.48 | 1.23 | 0.46 | 0.23 | 23 | 14 | 24 | 25 | 935 | 0 | 0 |
| Example 54 | | | | | | | | | | | |

TABLE 2

| | Preliminary annealing conditions | |
|---|---|---|
| | Holding temperature | Holding time |
| | (°C) | (s) |
| Embodiment 1 | 1000 | 90 |
| Embodiment 2 | 1000 | 90 |
| Embodiment 3 | 1000 | 90 |
| Embodiment 4 | 1000 | 90 |
| Embodiment 5 | 1000 | 90 |
| Embodiment 6 | 1000 | 90 |
| Embodiment 7 | 1000 | 90 |
| Embodiment 8 | 1000 | 90 |
| Embodiment 9 | 1000 | 90 |
| Embodiment 10 | 1000 | 90 |
| Embodiment 11 | 1000 | 90 |
| Embodiment 12 | 1000 | 90 |
| Embodiment 13 | 1000 | 90 |
| Embodiment 14 | 1000 | 90 |
| Embodiment 15 | 1000 | 90 |
| Embodiment 16 | 1000 | 90 |
| Embodiment 17 | 1000 | 90 |
| Embodiment 18 | 1000 | 90 |
| Embodiment 19 | 1000 | 90 |
| Embodiment 20 | 1000 | 90 |
| Comparative Example 1 | 1000 | 90 |
| Comparative Example 2 | 1000 | 90 |
| Comparative Example 3 | 1000 | 90 |
| Comparative Example 4 | 1000 | 90 |
| Comparative Example 5 | 1000 | 90 |
| Comparative Example 6 | 1000 | 90 |
| Comparative Example 7 | 1000 | 90 |
| Comparative Example 8 | 1000 | 90 |
| Comparative Example 9 | 1000 | 90 |
| Comparative Example 10 | 1000 | 90 |
| Comparative Example 11 | 1000 | 90 |
| Comparative Example 12 | 1000 | 90 |
| Comparative Example 13 | 1000 | 90 |
| Comparative Example 14 | 1000 | 90 |
| Comparative Example 15 | 1000 | 90 |
| Comparative Example 16 | 1000 | 90 |
| Comparative Example 17 | 1000 | 90 |
| Comparative Example 18 | 1000 | 90 |
| Comparative Example 19 | 1000 | 90 |
| Comparative Example 20 | 1000 | 90 |
| Comparative Example 21 | 1000 | 90 |
| Comparative Example 22 | 1000 | 90 |
| Comparative Example 23 | 1000 | 90 |
| Comparative Example 24 | 1000 | 90 |
| Comparative Example 25 | 1000 | 90 |
| Comparative Example 26 | 1000 | 90 |
| Comparative Example 27 | 1000 | 90 |
| Comparative Example 28 | 1000 | 90 |
| Comparative Example 29 | 1000 | 90 |
| Comparative Example 30 | 1000 | 90 |
| Comparative Example 31 | 1000 | 90 |
| Comparative Example 32 | 1000 | 90 |
| Comparative Example 33 | 1000 | 90 |
| Comparative Example 34 | 1000 | 90 |
| Comparative Example 35 | 1000 | 90 |
| Comparative Example 36 | 1000 | 90 |
| Comparative Example 37 | 1000 | 90 |
| Comparative Example 38 | 1000 | 90 |
| Comparative Example 39 | 1000 | 90 |
| Comparative Example 40 | 1000 | 90 |
| Comparative Example 41 | 1000 | 90 |
| Comparative Example 42 | 1000 | 90 |
| Comparative Example 43 | 1000 | 90 |
| Comparative Example 44 | 1000 | 90 |
| Comparative Example 45 | 1000 | 90 |
| Comparative Example 46 | 1000 | 90 |
| Comparative Example 47 | 1000 | 90 |
| Comparative Example 48 | 1000 | 90 |
| Comparative Example 49 | 1000 | 90 |
| Comparative Example 50 | 1000 | 90 |
| Comparative Example 51 | 1000 | 90 |
| Comparative Example 52 | 1000 | 90 |
| Comparative Example 53 | 900 | 90 |
| Comparative Example 54 | 1200 | 90 |

### Evaluation Example 1: Evaluation of the Average M_{AVG} of Magnetic Domain Spin Alignment Values

After manufacturing specimens with an area of 20 μm×20 μm from the non-oriented electrical steel sheets manufactured in each of the embodiments and comparative examples, a ctf file capable of extracting the crystal orientations of all grains was obtained for each specimen under a step size condition of 2 μm via electron backscatter diffraction (EBSD), each of α, β, and γ was obtained by converting the obtained crystal orientations into an ang file via 01M software, the magnetic domain spin alignment value M was calculated by plugging each of α, β, and γ into General Formula 1 below, then the average thereof M_{AVG} was determined, and the results are presented in Table 3 below.

M=(sin²α sin²β)+(sin²β sin²γ)+(sin²γ sin²α). [General Formula 1]

In General Formula 1 above, α, β, and γ are derived from crystal orientations measured under a step size condition of 10 μm via EBSD on a specimen of 20 mm in width and 20 mm in length manufactured from the non-oriented electrical steel sheet, and with respect to x-, y-, and z-axes defined in a three-dimensional crystal coordinate system, α is the angle formed between the x-axis and the crystal grain orientation, β is the angle formed between the y-axis and the crystal grain orientation, and γ is the angle formed between the z-axis and the crystal grain orientation.

### Evaluation Example 2: Evaluation of Iron Loss

A coating layer was formed by applying a chromium-free (Cr-free) coating solution to the surface of the non-oriented electrical steel sheet manufactured in each of the embodiments and comparative examples, heating it to 300 °C, and then slowly cooling and drying it, an iron loss W_{15/50} was then measured for the non-oriented electrical steel sheets with the coating layer formed on their surfaces in accordance with the method described in IEC 60404-2, and the results are presented in Table 3 below. In this case, W_{15/50} refers to the iron loss when a magnetic flux density of 1.5 T is induced at a low frequency of 50 Hz.

TABLE 3

| | M_{AVG} | W_{15/50} |
|---|---|---|
| Embodiment 1 | 1.206 | 6.02 |
| Embodiment 2 | 1.206 | 5.98 |
| Embodiment 3 | 1.188 | 5.84 |
| Embodiment 4 | 1.183 | 5.69 |
| Embodiment 5 | 1.214 | 6.09 |
| Embodiment 6 | 1.194 | 5.87 |
| Embodiment 7 | 1.219 | 5.55 |
| Embodiment 8 | 1.196 | 5.96 |
| Embodiment 9 | 1.215 | 5.99 |
| Embodiment 10 | 1.192 | 5.81 |
| Embodiment 11 | 1.199 | 5.84 |
| Embodiment 12 | 1.188 | 5.93 |
| Embodiment 13 | 1.203 | 5.99 |
| Embodiment 14 | 1.201 | 5.93 |
| Embodiment 15 | 1.196 | 5.83 |
| Embodiment 16 | 1.181 | 5.90 |
| Embodiment 17 | 1.204 | 5.97 |
| Embodiment 18 | 1.181 | 5.53 |
| Embodiment 19 | 1.199 | 5.97 |
| Embodiment 20 | 1.208 | 5.89 |
| Comparative Example 1 | 1.254 | 6.37 |
| Comparative Example 2 | 1.243 | 6.32 |
| Comparative Example 3 | 1.237 | 6.29 |
| Comparative Example 4 | 1.244 | 6.32 |
| Comparative Example 5 | 1.248 | 6.34 |
| Comparative Example 6 | 1.231 | 6.25 |
| Comparative Example 7 | 1.248 | 6.34 |
| Comparative Example 8 | 1.247 | 6.33 |
| Comparative Example 9 | 1.249 | 6.34 |
| Comparative Example 10 | 1.235 | 6.27 |
| Comparative Example 11 | 1.252 | 6.36 |
| Comparative Example 12 | 1.233 | 6.26 |
| Comparative Example 13 | 1.232 | 6.26 |
| Comparative Example 14 | 1.247 | 6.33 |
| Comparative Example 15 | 1.256 | 6.38 |
| Comparative Example 16 | 1.253 | 6.36 |
| Comparative Example 17 | 1.254 | 6.37 |
| Comparative Example 18 | 1.232 | 6.26 |
| Comparative Example 19 | 1.255 | 6.38 |
| Comparative Example 20 | 1.244 | 6.32 |
| Comparative Example 21 | 1.231 | 6.26 |
| Comparative Example 22 | 1.238 | 6.29 |
| Comparative Example 23 | 1.231 | 6.25 |
| Comparative Example 24 | 1.231 | 6.26 |
| Comparative Example 25 | 1.235 | 6.27 |
| Comparative Example 26 | 1.232 | 6.26 |
| Comparative Example 27 | 1.233 | 6.27 |
| Comparative Example 28 | 1.259 | 6.40 |
| Comparative Example 29 | 1.258 | 6.39 |
| Comparative Example 30 | 1.241 | 6.31 |
| Comparative Example 31 | 1.259 | 6.39 |
| Comparative Example 32 | 1.243 | 6.32 |
| Comparative Example 33 | 1.241 | 6.31 |
| Comparative Example 34 | 1.256 | 6.38 |
| Comparative Example 35 | 1.253 | 6.37 |
| Comparative Example 36 | 1.248 | 6.34 |
| Comparative Example 37 | 1.240 | 6.30 |
| Comparative Example 38 | 1.233 | 6.26 |
| Comparative Example 39 | 1.239 | 6.29 |
| Comparative Example 40 | 1.236 | 6.28 |
| Comparative Example 41 | 1.248 | 6.34 |
| Comparative Example 42 | 1.258 | 6.39 |
| Comparative Example 43 | 1.246 | 6.33 |
| Comparative Example 44 | 1.249 | 6.34 |
| Comparative Example 45 | 1.236 | 6.28 |
| Comparative Example 46 | 1.246 | 6.33 |
| Comparative Example 47 | 1.235 | 6.28 |
| Comparative Example 48 | 1.254 | 6.37 |
| Comparative Example 49 | 1.246 | 6.33 |
| Comparative Example 50 | 1.234 | 6.27 |
| Comparative Example 51 | 1.246 | 6.33 |
| Comparative Example 52 | 1.238 | 6.29 |
| Comparative Example 53 | 1.245 | 6.32 |
| Comparative Example 54 | 1.230 | 6.25 |

As shown in Tables 2 and 3 above, it was confirmed that since the non-oriented electrical steel sheets manufactured in each of Embodiments 1 to 20 were manufactured under particular preliminary annealing conditions and the compositional ratios of the non-oriented electrical steel sheets (slabs) satisfied a particular range, the M_{AVG} satisfied a specific range, thereby resulting in low iron loss. In contrast, it was confirmed that since the non-oriented electrical steel sheets manufactured in each of Comparative Examples 1 to 52 satisfied the particular preliminary annealing conditions but the compositional ratios of the non-oriented electrical steel sheets (slabs) failed to satisfy the particular range, the M_{AVG} did not satisfy the particular range, thereby resulting in high iron loss.

Furthermore, it was confirmed that since the non-oriented electrical steel sheets manufactured in each of Comparative Examples 53 and 54 failed to satisfy the particular preliminary annealing conditions and the compositional ratios of the non-oriented electrical steel sheets (slabs) failed to satisfy the particular range, the M_{AVG} did not satisfy the particular range, thereby resulting in high iron loss.

What is claimed:

1. A non-oriented electrical steel sheet comprising:
a) Si in an amount of i) 0.6 wt % or greater and ii) 1.6 wt % or less,
b) Al in an amount of i) 0.1 wt % or greater and ii) 0.5 wt % or less, and
c) Mn in an amount of i) 0.2 wt % or greater and ii) 0.4 wt % or less, and
d) one or more of: C in an amount of i) greater than 0 ppm and ii) 30 ppm or less, S in an amount of i) greater than 0 ppm and ii) 30 ppm or less, N in an amount of i) greater than 0 ppm and ii) 30 ppm or less, Ti in an amount of i) greater than 0 ppm and ii) 30 ppm or less, and P in an amount of i) greater than 0 ppm and ii) 1000 ppm or less, and
e) one or more of: Y in amount of i) greater than 0 ppm and ii) 30 ppm or less and Ho in an amount of i) greater than 0 ppm and ii) 30 ppm or less, with the balance being Fe and other unavoidable impurities,
wherein an average (M_{AVG}) of a magnetic domain spin alignment value (M) calculated by General Formula 1 below is 1.22 or less:
M=(sin²α sin²β)+(sin²β sin²γ)+(sin²γ sin²α), [General Formula 1]
in General Formula 1 above, α, β, and γ are derived from crystal orientations measured under a step size condition of 10 μm via EBSD on a specimen of 20 mm in width and 20 mm in length manufactured from the non-oriented electrical steel sheet, and with respect to x-, y-, and z-axes defined in a three-dimensional crystal coordinate system, α is an angle formed between the x-axis and a crystal grain orientation, β is an angle formed between the y-axis and a crystal grain orientation, and γ is an angle formed between the z-axis and a crystal grain orientation.

2. The non-oriented electrical steel sheet of claim 1, comprising Y at greater than 0 ppm and 30 ppm or less, and Ho at greater than 0 ppm and 30 ppm or less.

3. The non-oriented electrical steel sheet of claim 1, comprising C at greater than 0 ppm and 30 ppm or less, S at greater than 0 ppm and 30 ppm or less, N at greater than 0 ppm and 30 ppm or less, Ti at greater than 0 ppm and 30 ppm or less, and P at greater than 0 ppm and 1000 ppm or less.

4. The non-oriented electrical steel sheet of claim 1, having a thickness of greater than 0.3 mm and 0.6 mm or less.

5. A method of manufacturing a non-oriented electrical steel sheet, comprising:
hot-rolling a slab comprising a) Si in an amount of i) 0.6 wt % or greater and ii) 1.6 wt % or less, b) Al in an amount of i) 0.1 wt % or greater and ii) 0.5 wt % or less, and c) Mn in an amount of i) 0.2 wt % or greater and ii) 0.4 wt % or less, and d) one or more of: C in an amount of i) greater than 0 ppm and ii) 30 ppm or less, S in an amount of i) greater than 0 ppm and ii) 30 ppm or less, N in an amount of i) greater than 0 ppm and ii) 30 ppm or less, Ti in an amount of i) greater than 0 ppm and ii) 30 ppm or less, and P in an amount of i) greater than 0 ppm and ii) 1000 ppm or less, and e) one or more of: Y in amount of i) greater than 0 ppm and ii) 30 ppm or less and Ho in an amount of i) greater than 0 ppm and ii) 30 ppm or less, with the balance being Fe and other unavoidable impurities;
preliminarily annealing the hot-rolled steel sheet;
manufacturing a cold-rolled steel sheet by cold-rolling the preliminarily annealed hot-rolled steel sheet; and
finally annealing the cold-rolled steel sheet,
wherein the non-oriented electrical steel sheet has an average (M_{AVG}) of a magnetic domain spin alignment value (M), calculated by General Formula 1 below, of 1.22 or less:
M=(sin²α sin²β)+(sin²β sin²γ)+(sin²γ sin²α), [General Formula 1]
in General Formula 1 above, α, β, and γ are derived from crystal orientations measured under a step size condition of 10 μm via EBSD on a specimen of 20 mm in width and 20 mm in length manufactured from the non-oriented electrical steel sheet, and with respect to x-, y-, and z-axes defined in a three-dimensional crystal coordinate system, α is an angle formed between the x-axis and a crystal grain orientation, β is an angle formed between the y-axis and a crystal grain orientation, and γ is an angle formed between the z-axis and a crystal grain orientation.

6. The method of claim 5, wherein the slab comprises Y at greater than 0 ppm and 30 ppm or less, and Ho at greater than 0 ppm and 30 ppm or less.

7. The method of claim 5, wherein the slab comprises C at greater than 0 ppm and 30 ppm or less, S at greater than 0 ppm and 30 ppm or less, N at greater than 0 ppm and 30 ppm or less, Ti at greater than 0 ppm and 30 ppm or less, and P at greater than 0 ppm and 1000 ppm or less.

8. The method of claim 5, wherein the step of preliminarily annealing is performed by heat-treating the hot-rolled steel sheet at 950 °C or greater and 1100 °C or less for 30 seconds or greater and 150 seconds or less.

9. The method of claim 5 wherein the slab is reheated and then hot-rolled.
